(19) United States
(12) Patent Application Publication
(10) Pub. No.: US 2024/0296460 A1
(43) Pub. Date: Sep. 5, 2024

(54) CARBON FOOTPRINT ESTIMATION BASED ON BILL OF MATERIALS

(71) Applicant: SAP SE, Walldorf (DE)

(72) Inventors: Gopi Kishan, Raxaul (IN); Kavitha Krishnan, Bangalore (IN); Rohit Jalagadugula, Visakhapatnam (IN); Sai Hareesh Anamandra, Bengaluru (IN); Akash Srivastava, Lucknow (IN)

(73) Assignee: SAP SE, Walldorf (DE)

(21) Appl. No.: 18/117,234

(22) Filed: Mar. 3, 2023

(51) Int. Cl. G06Q 30/018; G06Q 10/0875

(52) U.S. Cl. CPC G06Q 30/018; G06Q 10/0875

(57) ABSTRACT

A computer-implemented method can instantiate a net graph based on one or more existing bills of materials for one or more known entities. The net graph includes a plurality of interconnected nodes representing different objects included in the one or more known entities, and the one or more existing bill of materials define relationship between the objects. The method can determine carbon footprint values of the objects represented by the nodes, collect vectors of object features and carbon footprint values corresponding to selected nodes in the net graph, train a machine learning model using the collected vectors of object features and the carbon footprint values corresponding to the selected nodes, receiving a request associated with a target entity different from the one or more known entities, and responsive to the request, generate an estimated carbon footprint value for the target entity based on the machine learning model.

### BACKGROUND

To improve corporate social responsibility (CSR), many organizations have been increasingly focused on their carbon usage. As a result, there has been an increasing demand to accurately measure, manage, compare, and track an organization's carbon footprint. For manufacturers, however, the task of measuring the exact carbon footprint in the lifecycle of a product can be exceedingly challenging. Accordingly, there remains a need for an improved system and method for more accurate assessment of carbon footprint of any given products.

### BRIEF DESCRIPTION OF THE DRAWINGS

FIG. 1 is an overall block diagram of an example computing system configured to estimate carbon footprint of objects based on bill of materials.

FIG. 2 is a flowchart illustrating an example overall method of determining carbon footprint of objects based on bill of materials.

FIG. 3 displays a portion of an example bill of materials in a spreadsheet format.

FIG. 4 is an example tree representation of a multi-level bill of materials for a skateboard.

FIG. 5 is a diagram illustrating an example trie data structure that can be used for fast object searching and node identification in a net graph.

FIG. 6 is an example net graph created from bill of materials corresponding to three different products P1, P2, and P3.

FIG. 7 is a flowchart illustrating an example method of determining carbon footprint of objects from a net graph.

FIG. 8 is an example net graph that is updated from the net graph of FIG. 6 by incorporating the bill of materials for another product P4.

FIG. 9 is a flowchart illustrating an example method of dynamically updating a net graph.

FIG. 10 is a flowchart illustrating an example overall method of estimating carbon footprint of an entity.

FIG. 11 is a flowchart illustrating an example overall method for collecting training data from a net graph.

FIG. 12 is a flowchart illustrating an example method of retrieving object features and carbon footprint value from non-leaf nodes of a net graph.

FIG. 13 is a schematic diagram illustrating feeding training data to a machine learning model.

FIG. 14 is a flow diagram illustrating an example process of estimating carbon footprint of an entity which has no corresponding bill of materials information.

FIG. 15 is a block diagram of an example computing system in which described embodiments can be implemented.

FIG. 16 is a block diagram of an example cloud computing environment that can be used in conjunction with the technologies described herein.

### DETAILED DESCRIPTION

### Example 1—Overview of Carbon Footprint Assessment

An organization's carbon footprint (CF) is the total greenhouse gas emissions caused by the organization, which can be measured by CO₂e, or carbon dioxide equivalent. Although carbon dioxide (CO₂) is the most common man-made greenhouse gas, there are other greenhouse gases such as methane, nitrous oxide, etc. The CO₂e is a standard unit for measuring carbon footprints. As described herein, the carbon footprint value of an object (or, entity, component, material, etc.) is a single number (expressed in CO₂e) representing the emissions of all greenhouse gases when manufacturing the object (or entity, component, material, etc.).

For manufacturers, however, the task of measuring the exact carbon footprint in the lifecycle of a product can be exceedingly challenging. This is because to measure the carbon footprint of the product, it is necessary to measure the carbon footprint of all components (including subcomponents) and/or materials used in the product. However, until the process flow pertaining to manufacturing the product becomes available, the complete list of components, subcomponents, and/or materials used in the product may not be known. Typically, the process flow of a product can include a bill of materials (BOM), which is a master list of components, subcomponents, and materials that are used to manufacture the product. The dependency of actual data in the process flow makes it difficult to evaluate the potential carbon footprint of a product if the product's process flow is not available.

For example, this can happen if the product is still in the design phase when the detailed process flow for making the product has not been fully documented, but the management team still wants to quickly assess the product's potential carbon footprint. As another example, this can also happen in a supply chain scenario. For example, a product manufactured by a company upstream in a supply chain may require multiple components sourced from different suppliers. The complete process flow for the product may not be available until the company receives the process flows for all components provided by those suppliers (and if a component has subcomponents sourced from other downstream suppliers, those components' process flows may further depend on the availability of process flows for those subcomponents provided by those other downstream suppliers, and so on). As a result, the company's ability to assess the product's carbon footprint can be restricted by its various suppliers downstream in the supply chain.

The technologies described herein provide a computing system and software tool which not only can accurately measure a product's carbon footprint when the product's process flow data is available, but also can reasonably estimate the product's carbon footprint when the product's process flow data is not available. Thus, the technologies described herein break the dependence of carbon footprint assessment on availability of actual process flow data and/or downstream suppliers. As a result, the computing system and software tool described herein can be used to provide an instant carbon footprint assessment for a product, even if the product's process flow information is missing and/or relevant data about the product's components have not been provided by suppliers.

### Example 2—Example Overview of Carbon Footprint Evaluation System

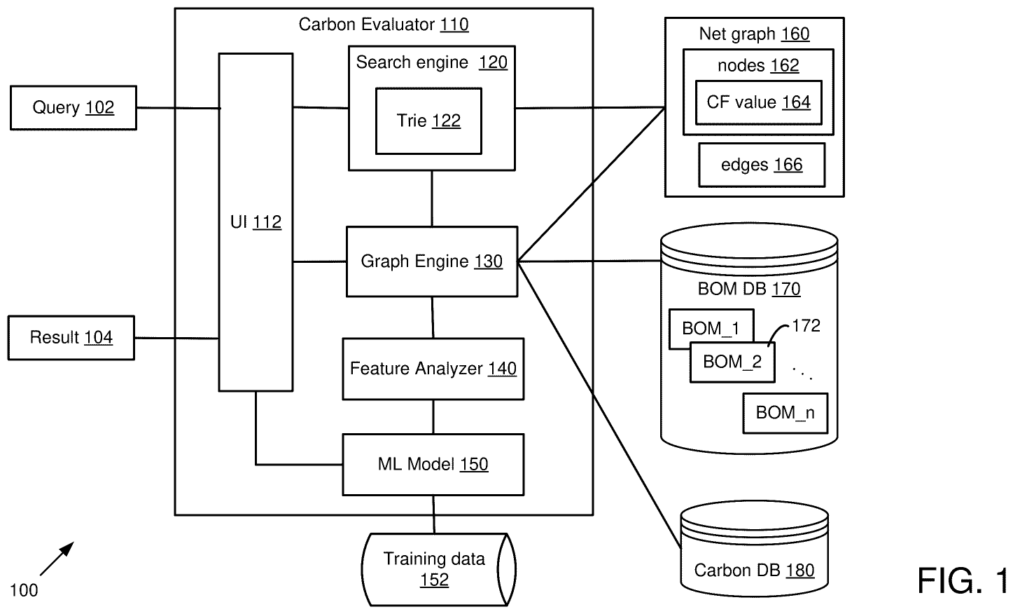

FIG. 1 shows an overall block diagram of an example system 100 configured to evaluate carbon footprint of objects.

As described herein, an object can represent a product, a component of a product, or a material being used to manufacture the component and/or the product. In some circumstances, a product, a component, or a component can also be referred to as an entity.

As shown in FIG. 1, the carbon footprint evaluation system 100 can have a carbon evaluator 110, which can include a user interface (UI) 112, a search engine 120, a graph engine 130, a feature analyzer 140, and a machine learning (ML) model 150. A user can send a query 102 to the carbon evaluator 110 through the user interface 112. The query 102 can request the carbon footprint values for one or more objects (e.g., products, components, materials, etc.). Responsive to the received query 102, the carbon evaluator 110 can determine the carbon footprint values for the specified objects, and return the query results 104 containing the determined carbon footprint values.

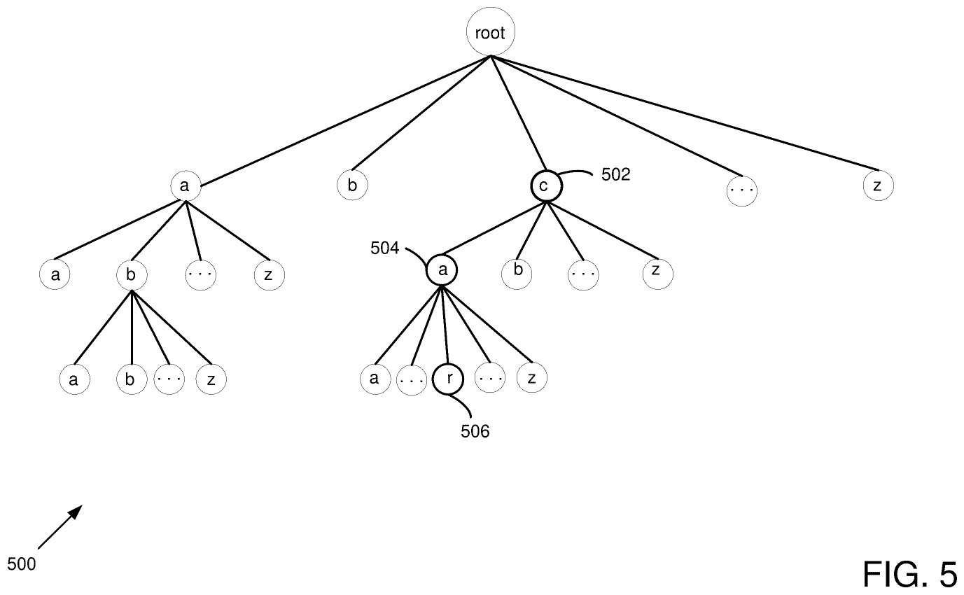

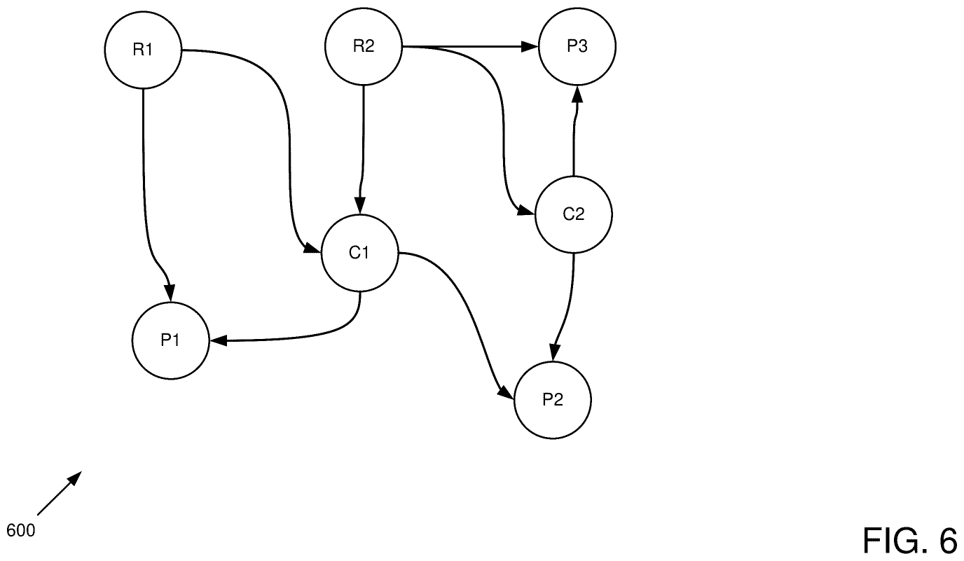

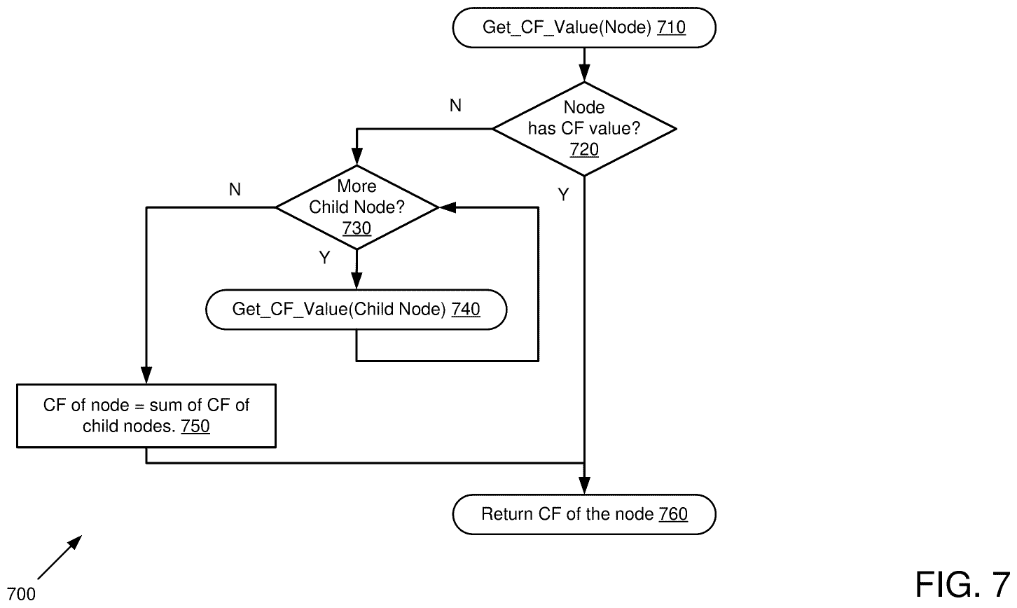

To determine the carbon footprint value of an object, the carbon evaluator 110 can search, via the search engine 120, if the object is represented in a net graph 160. In some examples, the search engine 120 can include a trie data structure 122, as illustrated in FIG. 5 and described further below. The net graph 160 can be instantiated based on an existing bill of materials corresponding to one or more known entities. For example, the system 100 can include a BOM database (DB) 170 storing a plurality of bills of materials 172. As shown in FIG. 6 and described further below, the net graph can include a plurality of nodes 162 interconnected by edges 166. The nodes 162 of the net graph 160 represent different objects included in the one or more known entities, and the bill of materials defines relationship between the objects. Each node 162 in the net graph 160 can have a corresponding carbon footprint value 164, representing the total carbon footprint for producing the object represented by the node 162. As illustrated in FIG. 7 and described further below, the carbon footprint value for different nodes 162 in the net graph 160 can be dynamically determined, on demand. In some examples, leaf nodes of the net graph 160 generally represent raw materials used for producing the object. In some examples, carbon footprint values for the leaf nodes (i.e., corresponding to the raw materials) can be obtained from a carbon database 180, which can be a publicly available database, or a proprietary database.

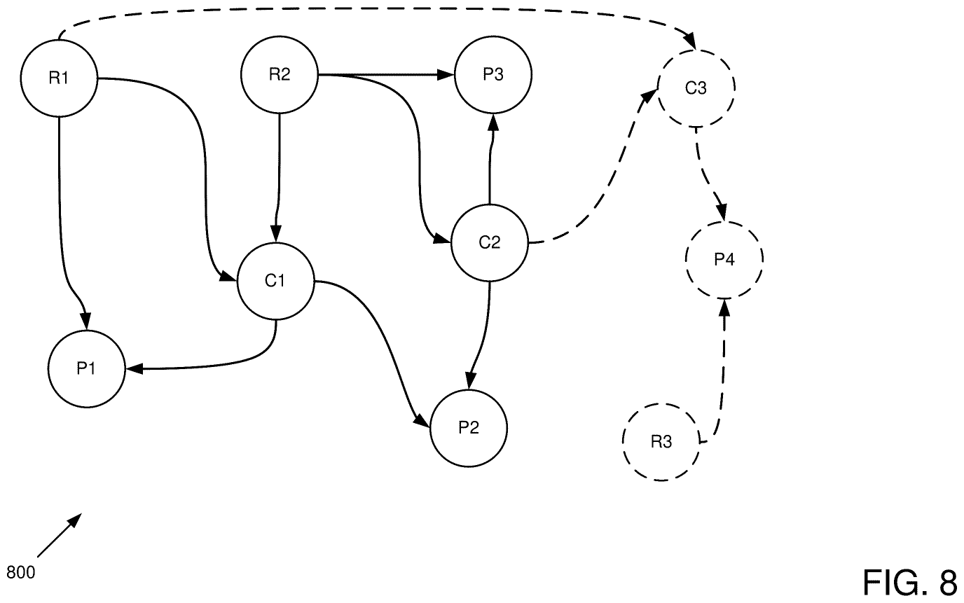

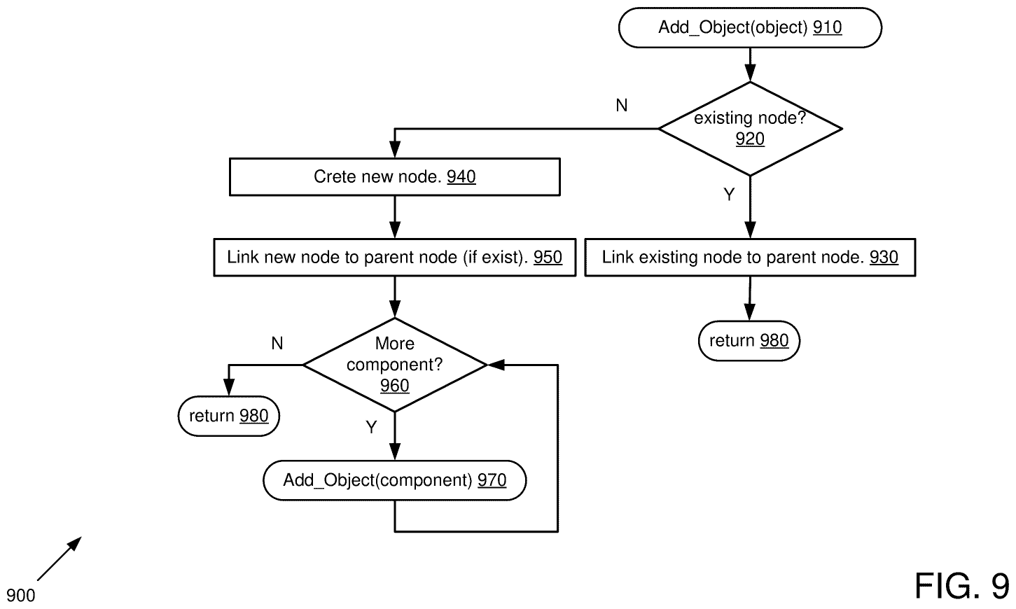

In some examples, the search engine 120 may not find the object in the net graph 160. For example, the object may have a new bill of materials not represented by the net graph 160 (e.g., a new BOM is recently added to the BOM database 170). In such circumstances, the carbon evaluator 110 may update the net graph 160, e.g., via the graph engine 130, to incorporate the new bill of materials. In fact, the net graph 160 can be initialized as null (i.e., without nodes or edges) and gradually expanded as more queries 102 are received to find carbon footprint values of new objects. Example methods of updating the net graph 160 are illustrated in FIGS. 8-9 and described further below.

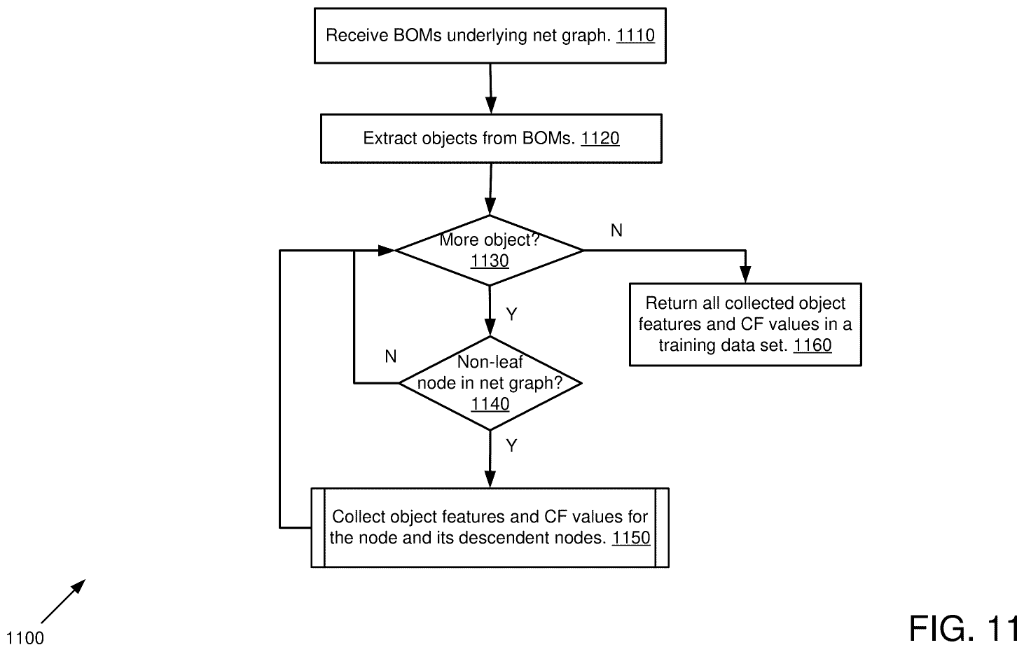

In some circumstances, the bill of materials for the unfound object (i.e., not represented in the net graph 160) may not be available in the BOM database 170 (e.g., a newly designed product without defined BOM, or the suppliers have not provided BOM information pertaining to certain components of a product). Under such circumstances, the carbon evaluator 110 can extract certain features of the object, e.g., via the feature analyzer 140, and feed those extracted features into the ML model 150, which can provide an estimated carbon footprint value of the object. The ML model 150 can be trained using a training dataset 152 collected from the net graph 160, as illustrated in FIG. 11 and described further below.

In practice, the systems shown herein, such as system 100, can vary in complexity, with additional functionality, more complex components, and the like. For example, there can be additional functionality within the carbon evaluator 110. As another example, although the training data 152, the net graph 160, the BOM database 170, the carbon database 180 are shown to be located outside the carbon evaluator 110 in FIG. 1, any of these components can be part of the carbon evaluator 110 in other examples. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the objects, nodes, carbon footprint values, bills of materials, features, and the like can be stored in one or more computer-readable storage media or computer-readable storage devices. The technologies described herein can be generic to the specifics of operating systems or hardware and can be applied in any variety of environments to take advantage of the described features.

### Example 3—Example Overall Method of Determining Carbon Footprint of Objects

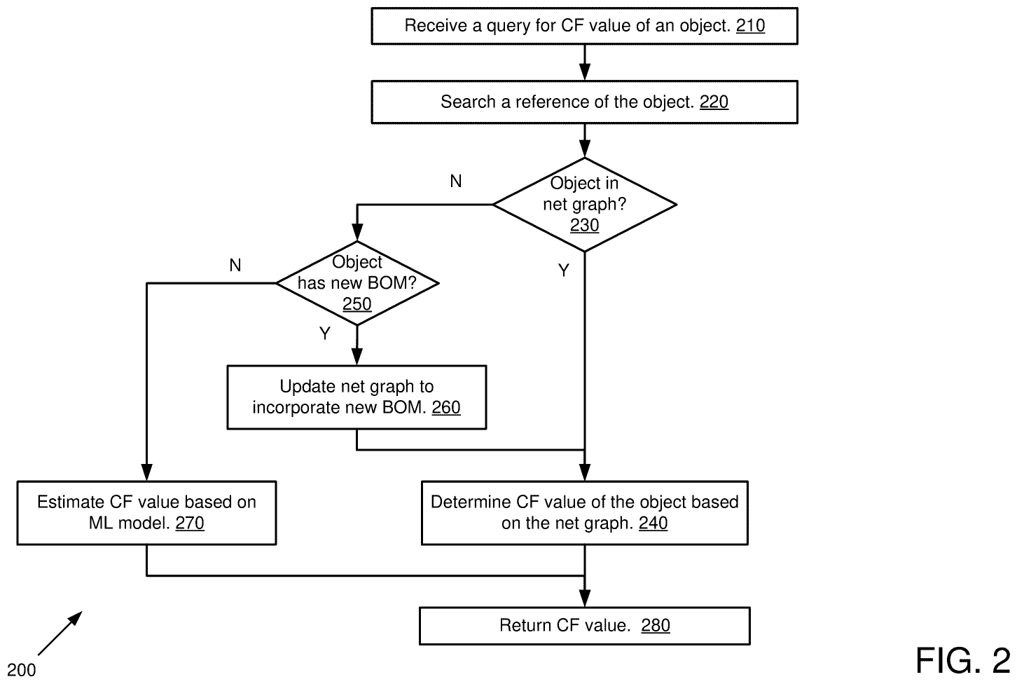

FIG. 2 is a flowchart of an example overall method 200 of determining carbon footprint of objects and can be performed, for example, by the system of FIG. 1.

At 210, a query for carbon footprint value of an object is received.

At 220, the method 200 can search a reference of the object (e.g., via a trie data structure). The reference of the object, if present, can point to a node in a net graph, as described further below.

At 230, a condition check is performed to determine if the reference of the object points to a node in the net graph (i.e., whether the object is represented by a node in the net graph).

If the condition check at 230 returns yes, the method 200 can proceed to 240 to determine the carbon footprint value of the object based on the net graph. An example method of determining carbon footprint values of objects based on a net graph is illustrated in FIG. 7 and described further below.

If the condition check at 230 returns no, the method 200 can proceed to 250 to perform another condition check to determine if the object is associated with a new bill of materials that is not represented by the net graph.

If the condition check at 250 returns yes, the method 200 can proceed to 260 to update the net graph to incorporate the new bill of materials. The method 200 can then proceed to 240 to determine the carbon footprint value of the object based on the updated net graph. An example method of updating the net graph is illustrated in FIG. 9 and described further below.

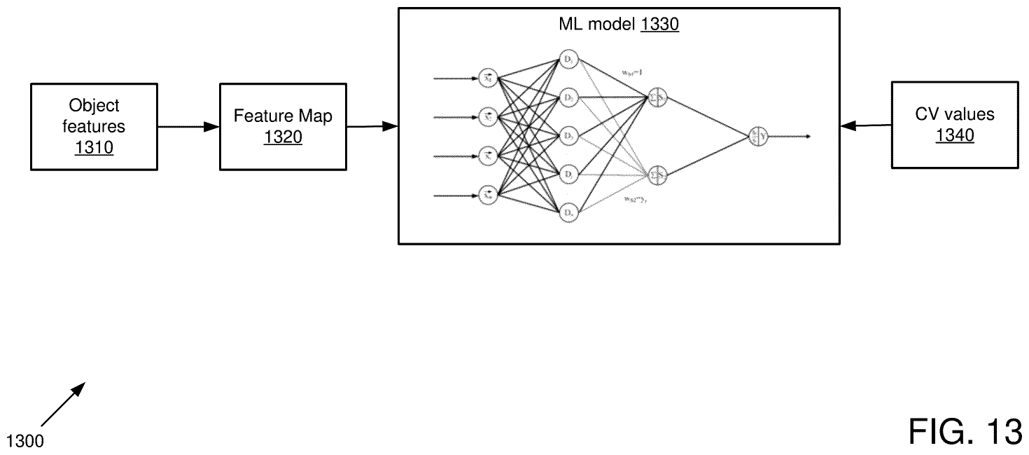

If the condition check at 250 returns no, the method 200 can proceed to 270 to estimate the carbon footprint value of the object based on a trained machine learning model, as illustrated in FIG. 13 and described further below.

At 280, the carbon footprint value determined from 240 or estimated from 270 can be returned in response to the query received at 210.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 4—Example Bill of Materials

In some examples, the process flow of manufacturing a product can be described in terms of a bill of materials of the product. As described herein, a bill of material (BOM) is a list of raw materials, assemblies, subassemblies, components, and parts required to manufacture a product. The bill of materials can be used to define relationships where one component comprises several subcomponents. In some circumstances, a maximum and a minimum quantity for each material and class can be defined in the bill of materials. Thus, a bill of materials can represent a comprehensive inventory of the raw materials, assemblies, subassemblies, parts, and components, as well as the quantities of each needed to manufacture a product.

As described herein, the terms “product,” “component,” “assembly,” “raw material,” etc., are relative terms and may be called differently according to manufacturing processes. For example, a camera can be deemed as an end product in one manufacturing process, but can be deemed as a component in another manufacturing process for a smart phone. As another example, aluminum may be deemed as either a raw material or a component in some manufacturing processes.

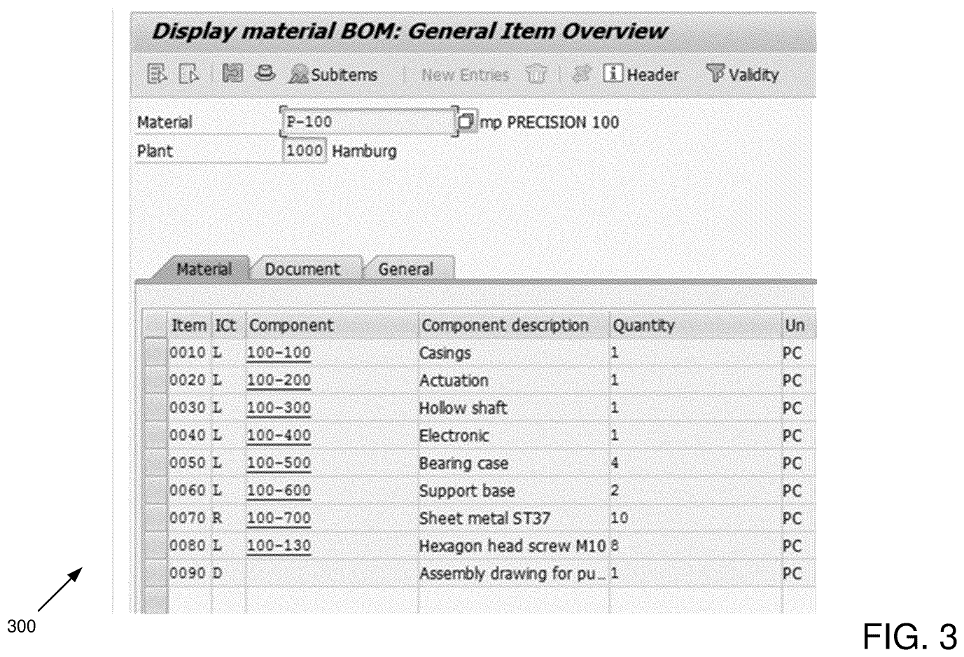

In some examples, a bill of materials can be displayed in a spreadsheet format including a list of items with a set of predefined and/or custom attributes (properties). As an example, FIG. 3 shows a portion of a bill of materials of an example product generated by SAP ERP Central Component (SAP ECC), a software product provided by SAP SE of Walldorf, Germany.

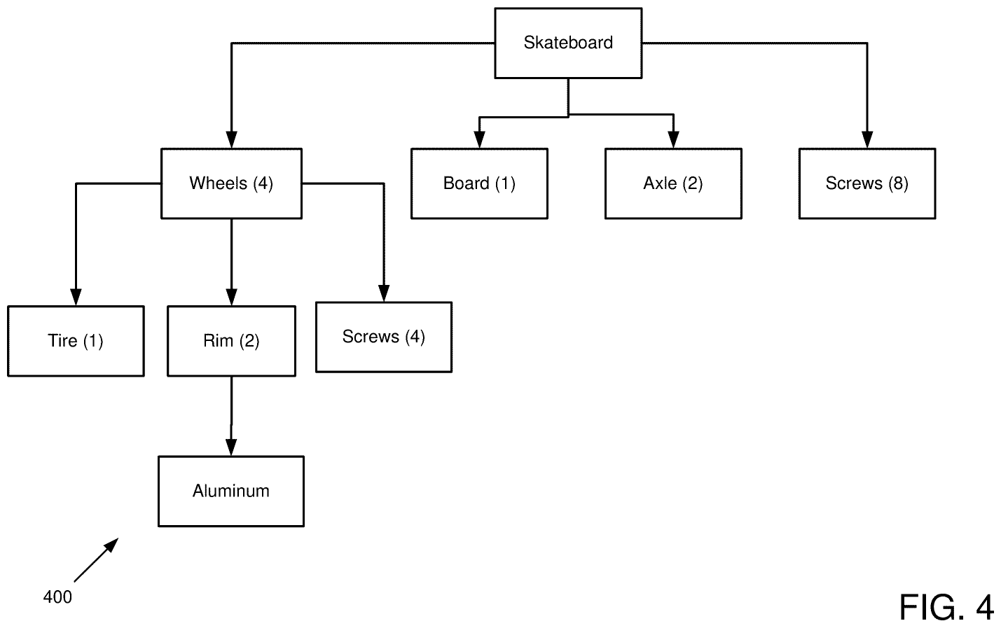

As described herein, each bill of materials can define a hierarchical structure for components and/or raw materials that make up a finished product. For example, the list of items in the spreadsheet can be indented to define parent-child relationships between each level of a product. Thus, the bill of material can be a nested list of components and assemblies in two or more levels of the product. Such multi-level bill of materials can be graphically represented in a tree diagram. As an example, FIG. 4 is a multi-level bill of materials of a skateboard represented in a tree diagram. As shown, the product “skateboard” comprises components (including respective quantities specified in parenthesis) wheels, board, axial, and screws; the component wheels comprises sub-components tire, rim, and screws; and the rim comprises a raw material aluminum. It is to be understood that the bill of materials depicted in FIG. 4 is a simplified version and additional details may be omitted. For example, each component or subcomponent can further branch into lower levels until reaching the lowest level raw materials (e.g., the tire may comprise raw material rubber and the screws may comprise raw material steel, etc.).

### Example 5—Example Object Searching

As described above with reference to FIG. 1, after receiving a query (e.g., 102) which requests the carbon footprint value for an object, a search can be performed (e.g., by the search engine 120) to determine if the object is represented in a net graph (e.g., 160). As described herein, each object specified in the query can have a name or identifier represented by a string, which can be efficiently found by looking up a pre-generated trie (e.g., 122).

A trie is a tree data structure used for locating specific keys from within a set. These keys can be strings, with links between nodes defined not by the entire string, but by individual characters. In order to access a string, the trie is traversed depth-first, following the links between nodes, which represent each character in the string. Trie is a type of k-ary search tree used for storing and searching a specific string from a string set. Using trie, search complexities can be brought to optimal limit (e.g., the string length). For example, the time complexity to search a string can be O(M), where M is the maximum string length.

As an example, FIG. 5 illustrates a trie 500 having three layers, representing a set of strings each having a maximum string length of 3. Each node represents a character and the links between nodes represent spelling sequences between the corresponding characters. A three-character word or string can be found from the trie 500 by identifying the nodes corresponding to each character of the word at respective depth levels. For example, the word “car” can be found by tracing the trie 500 to identify nodes 502, 504, and 506 in three different layers.

Although in the depicted example, the trie 500 has only three layers and only alphabet characters are used for the nodes, it is to be understood that in other examples, the trie can include many more layers (e.g., up to the longest string length allowed for the names or identifiers of objects specified in the query), and each node can be represented by non-alphabetic characters (e.g., numerals, special characters, etc.).

Each leaf node in the trie marks the end of the corresponding string (e.g., a trie node field “isEndOfWord” can be used to distinguish the node as the end of a string). In some examples, each leaf node can comprise a reference field. If there is a corresponding node in an existing net graph (as described further below) representing an object whose name or identifier matches a string in the trie, the reference field of the leaf node corresponding to the string can comprise a reference (e.g., an address) pointing to the node in the net graph. For example, if a car object (with an object name “car”) is represented by a node in an existing net graph, the leaf node 506 (marking the end of word “car”) can comprise a reference pointing to the corresponding node in the net graph. On the other hand, if the object identified by the string has no corresponding node in the existing net graph, the reference field of the leaf node corresponding to the string can be null. For example, if a turbine object (with an object name “turbine”) has no corresponding node in the net graph, the reference field of the leaf node (e.g., “e”) corresponding to the object name “turbine” is can be null.

Thus, for each object specified in the query (e.g., 102), a string can be found in the trie data structure. Checking the reference field of the leaf node of that string can indicate whether the object is represented by a corresponding node in an existing net graph, as indicated by step 230 of FIG. 2.

Although a trie data structure is described herein as an example to find a string matching the object name/identifier, and to further obtain a reference pointing to a node in a net graph (or null), other data structures can also be used. For example, a lookup table can be used to find a name/identifier for an object, and each entry in the lookup table can include a reference field that indicates whether the object is represented by a node in the corresponding net graph. In some examples, a hash function can be applied to the lookup table (i.e., to convert the lookup table into a hash table) for fast data retrieval.

### Example 6—Example Net Graph

As described herein, a net graph comprises a plurality of nodes representing different objects and directional edges connecting the nodes. The nodes can represent one or more products, different components of the products, and/or different raw materials used in the components and/or products.

The net graph can be instantiated based on one or more existing bills of materials (e.g., 172 of FIG. 1) corresponding to one or more entities or products. The method of creating and updating the net graph based on the bills of materials is described further below in reference to FIGS. 8-9.

As described above, a bill of materials can define a hierarchical structure for components and/or raw materials that are used in a finished product. Accordingly, the edges connecting the nodes in the net graph represent the hierarchical relationship between the objects represented by the nodes based on the existing bill of materials.

As an example, FIG. 6 shows a net graph 600 created from three bills of materials corresponding to three different products, denoted as P1, P2, and P3. Besides three nodes representing the three finished products (P1, P2, and P3), the net graph 600 also includes two nodes representing two components, denoted as C1 and C2, as well as two leaf nodes representing two different raw materials, denoted as R1 and R2.

The directional edges connecting the nodes depict parent-child relationship between the objects represented by the node (e.g., the arrow of an edge points to a parent object and the tail of the edge points to a child object). In this example, the product P1 comprises component C1 and raw component R1. The component C1 comprises raw materials R1 and R2. The product P2 comprise components C1 and C2. The component C2 comprises raw material R2. The product P3 comprises raw material R2 and component C2.

In certain examples, each node in the net graph 600 can comprise a node identifier (ID) and an array of references pointing to the IDs of its child nodes. For example, the node C1 can have two references respectively point to the IDs of R1 and R2, the node P1 can have two references respectively point to the IDs of R1 and C1, and so on. For a leaf node that represents a raw material (e.g., R1, R2, etc.), the node's array of references can be empty, indicating that the node has no child node.

As described herein, for each given node, all lower-level nodes that have directional edges connected to (and with arrowed direction pointing to) the given node, either directly or indirectly, can also be referred to as descendent nodes of the given node. For example, the descendant nodes of node P1 includes nodes R1 and C1; the descendant nodes of node P2 includes nodes C1, C2, R1, and R2; the descendant nodes of node P3 includes nodes C2 and R2; etc.

As described above, if an object is represented by a node in the net graph 600, a reference to the node's ID can be stored in the reference field of a leaf node of a trie data structure (e.g., 500) corresponding to a name/identifier of the object. For example, if a car object (with an object name “car”) is represented by the node P3 in the net graph 600, the leaf node 506 can comprise a reference pointing to the ID of node P3 in the net graph 600.

As described herein, each node in the net graph 600 can also include a carbon footprint (CF) field, which can store total carbon footprint value for producing the object represented by the node. For example, the CF field of node P2 can store total carbon footprint value for producing the product P2, the CF field of node C1 can store total carbon footprint value for producing the component C1, the CF field of node R1 can store total carbon footprint value for producing the raw material R1, etc.

In some examples, each node in the net graph 600 can further include a feature vector. The feature vector can be empty for leaf nodes representing raw materials. For nodes representing components or products, each feature vector can include a set of feature names (keys) and corresponding feature values for the component or product. The length of feature vector for different nodes can vary, depending on what features are of interests for objects represented by the nodes. Such feature vectors can be used for training a machine learning model for carbon footprint estimation, as described further below.

An example pseudo-code structure definition of nodes in a net graph is shown below:

```
Struct NetGraphNode {
  Node_id : number // unique identifier of a node
  CF: number // equivalent carbon footprint value
  ChildGraphNode : vector<Node_id>[ ] // list of IDs of child nodes
  FeatureVector : set<key, value> // set of feature names and values
}
```

In some examples, the total carbon footprint value for each raw material (e.g., R1, R2, etc.) can be directly retrieved from an existing carbon database (e.g., 180 of FIG. 1). In certain examples, the total carbon footprint value for each component (e.g., C1, C2, etc.) or product (e.g., P1, P2, P3, etc.) can be dynamically calculated, on demand, as described below in reference to FIG. 7. Until such calculation is made (on demand), the CF field of the node can remain empty or null.

### Example 7—Example Method of Dynamically Determining Carbon Footprint Values from the Net Graph

FIG. 7 a flowchart illustrating an example method 700 of dynamically determining the carbon footprint value of an object from a net graph (e.g., 600), and can be performed, e.g., by the search engine 120 of FIG. 1.

In some examples, the method 700 implements the step 240 of FIG. 2, thus it is invoked only after determining that the object is represented by a node in the net graph (e.g., the condition check 230 of FIG. 2 returns yes).

In some examples, the method 700 can be implemented by invoking a function Get_CF_Value(Node) or the like at 710, where the input parameter “Node” identifies a node in the net graph (e.g., the “Node” can be the node ID stored in the reference field of a leaf node of a trie corresponding to the name or identifier of the object).

At 720, a condition check can be performed to determine if the identified node in the net graph has a valid value in its CF field.

If the condition check at 720 returns yes (i.e., the CF field of the identified node was already calculated, on demand, in a previous query), then the method 700 can proceed to 760 and return the total carbon footprint value stored in the CF field of the identified node.

On the other hand, if the condition check at 720 returns no (i.e., the CF field of the identified node is empty), then the method 700 can proceed to another condition check at 730 to determine if the identified node has any child nodes (e.g., checking if the array of references pointing to the IDs of child nodes).

If the condition check at 730 returns yes, then for each child node of the identified node, the method 700 can recursively invoke the function Get_CF_Value(Child Node) or the like at 740, where the input parameter “Child Node” identifies a child node of the identified node.

After all the child nodes of the identified node are processed, the method 700 can proceed to 750 to aggregate the CF values of all child nodes, and assign the sum to the CF field of the identified node. Then, the carbon footprint value stored in the CF field of the identified node can be returned at 760.

In any of the examples described herein, if the identified node is a leaf node that represents a raw material (e.g., R1 or R2 in FIG. 6), the condition check at 720 always returns yes because the total carbon footprint value for the raw material is deemed to be always available, e.g., by retrieving directly from an existing carbon database (e.g., 180 of FIG. 1). Thus, the condition check at 730 always occur for nodes representing components (e.g., C1, C2, etc.) or products (e.g., P1, P2, P3, etc.) that have child nodes (representing sub-components).

Thus, the method 700 described above can calculate the carbon footprint value of an identified object by aggregating the carbon footprint values of all objects that are components of the identified object. For example, referring to FIG. 6, the carbon footprint value of product P1 is the sum of total carbon footprint values of component C1 and raw component R1; the carbon footprint value of component C1 is the sum of total carbon footprint values of raw materials R1 and R2; the carbon footprint value of product P2 is the sum of total carbon footprint values of components C1 and C2; the carbon footprint value of component C2 equals the total carbon footprint value of raw material R2; the carbon footprint value of product P3 is the sum of total carbon footprint values of raw material R2 and component C2.

Notably, the method 700 described above calculates the carbon footprint values of nodes on demand. For example, all nodes in the net graph 600 can initially have an empty CF field. Only after the function Get_CF_Value(Node) is called, do the CF field of the identified node and the CF fields of all its child nodes are calculated. For each node, after calculating its CF value on demand, such calculated CF value can be retained or cached in the CF field so that when the next time the node is involved in a query, its CF value can be directly returned (e.g., in FIG. 7, the condition check at 720 returns yes, thus directly returning the CF of the node at 760). In other words, the CF field of a node only needs to be calculated once (when the CF value of the node is first requested, e.g., by the function call Get_CF_Value( )). Thereafter, the CF value of the node can be memorized and directly used.

For example, referring to FIG. 6, the CF fields of all nodes can be initialized to empty. Assuming a first query requests the CF of product P1. Invoking the method 700 above can not only calculate the CF field of P1, but also recursively calculate the CF fields of R1 and C1. When a second query requests the CF of product P2, invoking the method 700 can additionally calculate the CF fields of P2, C2, and R2. When a third query requests the CF of product P3, invoking the method 700 can further calculate the CF field of P3.

Determining the CF values of nodes in a net graph on demand is more advantageous than calculating the CF value of all nodes in the net graph at once, e.g., right after the net graph is constructed. This is because the net graph can comprise thousands or even millions of nodes. Calculating the CF values for all nodes at once can be time consuming, whereas calculating the CF values of nodes on demand can divide the computation into smaller tasks, each of which can take negligible amount of time to complete. Further, in some circumstances, calculating the CF values for all nodes at once can be unnecessary. For example, it is possible that the CF of certain products or components may never be queried. Thus, pre-calculating the CF values for those corresponding nodes may represent a waste of computing resources.

### Example 8—Example Method of Dynamically Updating Net Graph

As described herein, a net graph instantiated based on one or more existing bills of materials can be dynamically updated by incorporating a new bill of materials different from the one or more existing bills of materials.

As an example, FIG. 8 shows a new net graph 800 that is updated from the net graph 600 of FIG. 6. In this example, the new bill of materials corresponds to a new product, denoted as P4. Besides the newly created node representing the product P4, the updated net graph 800 also includes a new node representing a component C3 and another new leaf node representing a raw material R3. Based on the hierarchical relationship defined in the new bill of materials, these newly created nodes (shown in dashed circles) can be interconnected. Additionally, at least some of these newly created nodes can be connected to existing nodes by directional edges (the newly created edges are shown in dashed arrows). For example, FIG. 8 shows that product P4 comprises raw material R3 and component C3, and component C3 comprises component C2 and raw material R1.

FIG. 9 is a flowchart illustrating an example method 900 of dynamically updating a net graph, and can be performed, e.g., by the graph engine 130 of FIG. 1.

In some examples, the method 900 implements the step 260 of FIG. 2, thus it is invoked only after determining that an object is not represented by a node in the net graph (e.g., the condition check 230 of FIG. 2 returns no) and the object is included in a new bill of materials (e.g., the condition check 250 of FIG. 2 returns yes).

In some examples, the method 900 can be implemented by invoking a function Add_Object(Object) or the like at 910, where the input parameter “Object” identifies a new object (e.g., denoting a new product, etc.) to be added to the net graph.

At 920, a condition check is performed to determine if the object to be added is already represented by an existing node in the net graph. As described above, such condition check can be performed by searching a reference of the object via a trie data structure. But for the new object (e.g., product P4), this condition check always returns no because the new object is already determined (e.g., at 230) to be not represented by a node in the net graph.

If the condition check at 920 returns no, the method 900 can proceed to 940 to create a new node for the object.

At 950, if the newly created node has a parent node, the newly created node can be linked to the parent node, e.g., by a directional edge pointing from the newly created node to the parent node. This generally occurs when the Add_Object( ) function is later recursively invoked, as described below. For the first time the Add_Object( ) function is invoked, the new object (e.g., product P4) has no known parent node, thus, the step 950 can be skipped.

At 960, another condition check 970 can be performed to determine if the object comprises any more components (including raw materials).

If the condition check 970 returns yes, then the method 900 can proceed to 970 to recursively invoke the Add_Object( ) function by specifying one of the component as an input parameter. Such recursive invocation of Add_Object( ) function can be continued until all components of the object are processed.

If the condition check 970 returns no, then the method 900 can return at 980. This can occur, e.g., when the object itself is already a raw material, or all components of the object have been recursively processed.

If the condition check 920 returns yes, then the method 900 can proceed to 930 to link the existing node to its parent node, e.g., by a directional edge pointing from the existing node to its parent node, and then return at 980. This can occur when recursively calling the Add_Object( ) function, for example, when a component is found to be already represented by a node in the existing net graph.

Thus, the method 900 described above can dynamically update the net graph by creating new nodes when necessary and linking to some shared nodes if existing. For example, referring to FIG. 8, when the first time the method 900 invokes Add_Object(P4) (i.e., using P4 as an input parameter at 910), a new node representing product P4 can be created at 940 because the product P4 is not represented in the original net graph. Because the new bill of materials specifies that product P4 comprises component C3 and raw material R3, the Add_Object( ) function can be recursively invoked twice by using C3 and R3 as input parameters, respectively. Because neither C3 nor R3 is represented in the original net graph, two new nodes represent component C3 and raw material R3 can be created (again at 940) and linked to their parent node P4 (at 950).

No additional node is generated when invoking Add_Object(R3) because the raw material R3 cannot be further divided into sub-components. Invoking Add_Object(C3) also does not create new node in this example. This is because the new bill of materials specifies that component C3 comprises component C2 and raw material R1, both of which are already represented by nodes in the existing net graph. Thus, recursively invoking Add_Object(C2) and Add_Object(R1) simply create directional links from the existing nodes C2 and R1 to their parent node C3, respectively (at 930).

Thus, if the new bill of materials includes new objects (e.g., P4, C3, R3) not represented by any node of the net graph, then new nodes can be created for these new objects. On the other hand, if the new bill of materials includes some common objects (e.g., C2, R1) already represented by existing nodes in the net graph, these existing nodes can be shared and linked to at least some of the newly created nodes (e.g., both C2 and R1 are connected to C3). In other words, the newly created nodes (e.g., P4, C3, R3) can be connected to one or more shared nodes (e.g., C2, R1) based on the hierarchical relationship between objects defined in the new bill of materials.

In some examples, the net graph can be initialized to be null or empty, i.e., without a single node or edge. Using the method 900, the net graph can be gradually expanded as more queries (e.g., 102) are received to find carbon footprint values of new objects provided that the new objects are specified in respective bills of materials.

For example, the net graphs 600 of FIG. 6 can be incrementally expanded by repetitive execution of the method 900 responsive to sequential queries. To illustrate, let us assume the net graph is initialized to be null. Further assuming a first query requests the CF of product P1, which has a corresponding bill of materials. Invoking the method 900 above can thus create new nodes representing P1, C1, R1, and R2, as well as directional edges between these nodes based on the bill of materials for product P1. Let us assume that a second query requests the CF of product P2, which has a corresponding bill of materials. Invoking the method 900 above again can thus create new nodes representing P2 and C2 and some new directional edges based on the bills of materials for product P2 (e.g., C2 is linked to P2, R2 is linked to C2, and C1 is linked to P2). Similarly, after receiving a third query that requests the CF of product P3 (which has a corresponding bill of materials), the method 900 can again be invoked to create a new node represent P3 and two new directional edges (e.g., R2 is connected P3, C2 is connected to P3). The end result will be the net graphs 600 of FIG. 6. If a fourth query requests the CF of product P4 (which has a corresponding bill of materials), the method 900 can again be invoked to update the net graph 600 to the new net graph 800, as described above.

In any of the examples described above, once a node is incorporated in the net graph, the CF of the object represented by the node can be determined, e.g., using the method 700 described above. This is also illustrated in FIG. 2, in which the step 240 (determining the CF value of an object) can be executed after step 260 (updating the net graph to incorporate a new bill of materials).

Notably, the method 900 described above creates new nodes on demand, that is, a new node is created only when an object not represented in the original net graph needs to be evaluated (e.g., obtaining the CF value of the object).

Creating new nodes on demand (e.g., as new queries are received) is more advantageous than creating a complete net graph to include all possible nodes at once. This is because a complete net graph can comprise thousands or even millions of nodes representing objects specified in many bills of materials. Generating, all at once, a comprehensive net graph incorporating all available bills of materials can be time consuming and require a large memory/storage space. Incrementally expanding the net graph on demand can divide the computation into smaller tasks, each of which can take negligible amount of time to complete. Further, in some circumstances, generating a complete net graph incorporating all available bills of materials can be unnecessary. For example, it is possible that the CF of certain products may never be queried. Thus, populating the net graph to incorporate the bill of materials corresponding to those products may represent a waste of computing resources. Incrementally expanding the net graph on demand may lead to a smaller net graph, thus saving memory/storage space.

### Example 9—Example Overall Method of Estimating Carbon Footprint Values of New Objects Having No BOM

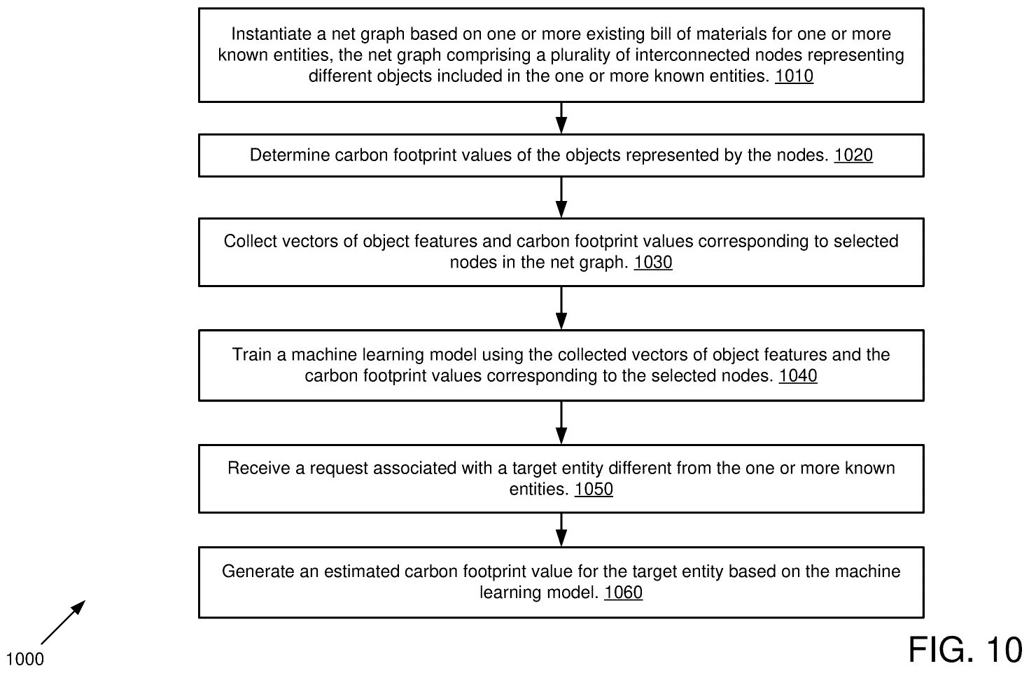

FIG. 10 is a flowchart illustrating an example overall method 1000 of estimating carbon footprint of an entity, e.g., a new product that has no available bill of materials, and can be performed, e.g., by the carbon evaluator 110 of FIG. 1.

At 1010, a net graph can be instantiated based on one or more existing bills of materials (e.g., 172 of FIG. 1) for one or more known entities (e.g., products). The resulting net graph includes a plurality of interconnected nodes representing different objects included in the one or more known entities. The one or more existing bills of materials can define relationship between the objects. The method 900 described above can be used to instantiate the net graph (e.g., after processing a series of queries involving some of the entities).

At 1020, carbon footprint values of the objects represented by the nodes can be determined, for example, by using the method 700 described above (e.g., after processing a series of queries involving some of the entities). As described above, the determined carbon footprint values of the objects can be stored in the CF field of corresponding nodes.

At 1030, vectors of object features and carbon footprint values corresponding to selected nodes in the net graph can be collected. In certain examples, the selected nodes includes all nodes representing products or components, but not leaf nodes representing raw materials. As described above, each node representing a product or component can have a feature vector including one or more pairs of feature names and corresponding feature values.

At 1040, a machine learning model can be trained using the collected vectors of object features and the carbon footprint values corresponding to the selected nodes.

At 1050, a request associated with a target entity (e.g., a new product) different from the one or more known entities is received. The request can be a query requesting the carbon footprint of the target entity. The target entity is not represented by the net graph and the bill of material for the target entity may not be available.

At 1060, responsive to the request, an estimated carbon footprint value for the target entity can be generated based on the trained machine learning model (similar to step 270 of method 200 depicted in FIG. 2).

### Example 10—Example Method of Training Data Collection

Each product or component specified in a bill of materials can have a plurality of features that characterize properties and/or status of the product or component. Example features can include BOM level, phase, manufacturing process, composition, product code, part name, part number, part revision, description, quantity, unit of measure, size, length, weight, procurement type, etc. If a product or component is represented by a node in a net graph, the features corresponding to the product or component can be stored in the node's feature vector. Different nodes can have different and/or variable length feature vectors.

As described above, each feature vector stored in a node can include a set of feature names and corresponding feature values for the product or component. The feature names can be strings. The feature values can have different data types (e.g., strings, numbers, Booleans, etc.). In some examples, the feature values can be converted into a string format. Thus, each pair of feature name and corresponding feature value can be combined to represent an element of the feature vector. For example, certain elements of a feature vector in a node can be “BOM level: 3,” “phase: III,” “product code: A07,” “part number: 001546,” etc.

In some examples, training data set can be collected from a net graph. Specifically, the training data include feature vectors and carbon footprint values stored in each non-leaf node (i.e., a node representing a product or component) of the net graph. FIG. 11 is a flowchart illustrating an example method 1100 for collecting training data from a net graph.

At 1110, the method 1100 can receive one or more bills of materials underlying a net graph (e.g., 600, 800, etc.). Then, at 1120, the method 1100 can extract all objects from the one or more bills of materials. The extracted objects can be processed one by one (e.g., processing the steps if the condition check at 1130 returns yes) until all extracted objects have been processed (e.g., if the condition check at 1130 returns no).

At 1140, the method 1100 checks if the node representing an extracted object is a leaf node in the net graph. If yes, the object represents a raw material and its feature vector is empty. The method 1100 can return to 1130 to find another object for processing. If no, the object represents a product or component. The method 1100 can proceed to 1150 to collect object features and carbon footprint values for this node, as well as for all its non-leaf descendant nodes. Each object feature represents an element of a corresponding feature vector, thus including a pair of feature name and the corresponding feature value. As described herein, the object features and carbon footprint values retrieved from one node collectively represent one data sample (for later model training). Then, the method 1100 can return to 1130 to process another extracted object. After all extracted objects have been processed, the method 1100 can return at 1160 by placing all collected object features and carbon footprint values (i.e., all collected data samples) in a training data set.

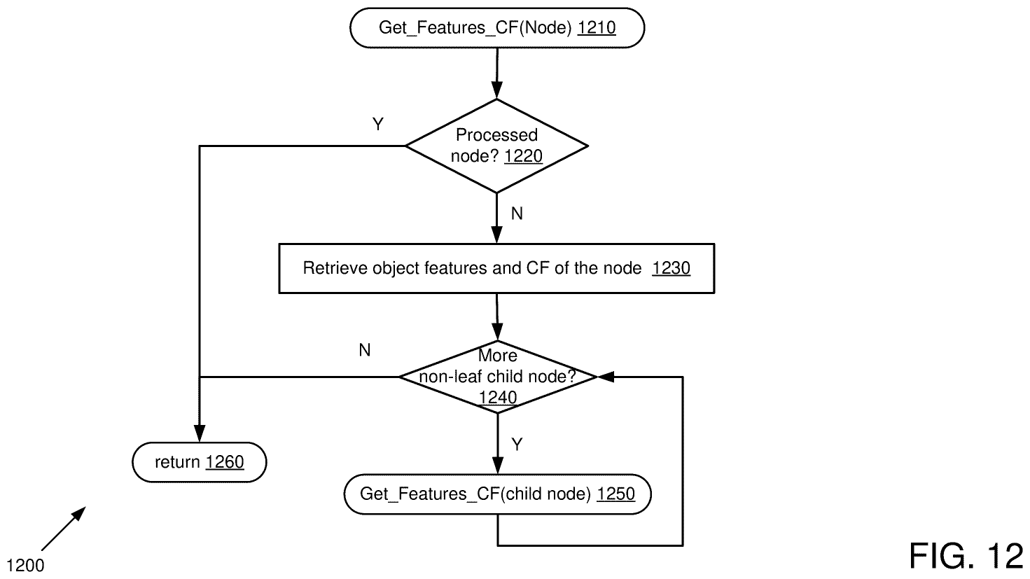

The method step 1150 can include additional sub-steps, as illustrated in FIG. 12, which shows a flowchart of an example method 1200 of retrieve object features and carbon footprint values of a node and its non-leaf descendant nodes.

The method 1200 can start at 1210 with a function call, e.g., Get_Features_CF(Node) or the like, wherein the input parameter “Node” identifies a node in the net graph.

At 1220, the method 1200 can check if the identified node has already been processed. If yes, it means the object features and carbon footprint value of this identified node have already been retrieved. Thus, no processing is needed and the method can return at 1260. Otherwise, the method 1200 can proceed to 1230 to retrieve object features (e.g., from the Feature Vector field) and carbon footprint value (e.g., from the CF field) from the identified node (i.e., to generate a data sample from the identified node).

At 1240, the method 1200 can check if the identified node has any non-leaf child nodes. If no, the method 1200 will return at 1260. Otherwise, for each found non-leaf child node, the method 1200 can recursively invoke the Get_Features_CF(child node) function, where the input parameter identifies a child node of the identified node.

### Example 11—Example Method of Model Training

As described above, the training data set is a collection of object features and corresponding carbon footprint values for all products and components represented in a net graph. Because the feature vectors of different products and components can be heterogenous, the collected object features need to be first standardized before used in model training. As illustrated in FIG. 13, the collected object features 1310 can be first converted to a standardized feature map 1320 before feeding to the input end of a machine training model 1330, and the corresponding carbon footprint values 1340 can be provided as output to the machine learning model 1330. The method of converting the object features 1310 to the feature map 1320 is described below, and can be performed, e.g., by the feature analyzer 140 of FIG. 1. In the depicted example, the machine learning model 1330 includes a multi-layer neural network, although it is to be understood that other predictive models can also be used.

In certain examples, a superset of unique features can be constructed from the collected object features. A simplified example is described here for purposes of illustration. Let us assume the collected training data set has the following three data samples which include object features and carbon footprint values retrieved from three non-leaf nodes:

| Samples | Object Features | Carbon footprint |
|---|---|---|
| Sample 1 | {F1, F2, F3, F4, F5} | CF1 |
| Sample 2 | {G1, G2} | CF2 |
| Sample 3 | {H1, H2, H3} | CF3 |

A super feature set can be constructed as a union of all collected object features. In this example, if F1-F5, G1-G2, and H1-H3 are all distinct features, then the super feature set will be {F1, F2, F3, F4, F5, G1, G2, H1, H2, H3} (i.e., the dimension of the super feature set is the total number of collected object features). On the other hand, if there are duplicate object features, the dimension of the super feature set can be less than the total number of collected object features. For example, if F5=G1 and G2=H2, then the super feature set will be {F1, F2, F3, F4, F5, G2, H1, H3}.

After constructing the super feature set, each feature vector (containing the object features retrieved from a corresponding node) can be standardized by first expanding the feature vector to the dimension of the super feature set, and then setting each object feature in the expanded feature vector to a binary value (e.g., 1 or 0) depending on whether the object feature matches a corresponding element in the super feature set. For example, assuming the super feature set is {F1, F2, F3, F4, F5, G1, G2, H1, H2, H3}, then the standardized feature vector corresponding to the above three data samples will become:

| Samples | Standardized feature vectors | Carbon footprint |
|---|---|---|
| Sample 1 | {1, 1, 1, 1, 1, 0, 0, 0, 0, 0} | CF1 |
| Sample 2 | {0, 0, 0, 0, 0, 1, 1, 0, 0, 0} | CF2 |
| Sample 3 | {0, 0, 0, 0, 0, 0, 0, 1, 1, 1} | CF3 |

As another example, if the super feature set is {F1, F2, F3, F4, F5, G2, H1, H3} (e.g., assuming F5=G1 and G2=H2), then the standardized feature vector corresponding to the above three data samples will become:

| Samples | Standardized feature vectors | Carbon footprint |
|---|---|---|
| Sample 1 | {1, 1, 1, 1, 1, 0, 0, 0} | CF1 |
| Sample 2 | {0, 0, 0, 0, 1, 1, 0, 0} | CF2 |
| Sample 3 | {0, 0, 0, 0, 0, 1, 1, 1} | CF3 |

Thus, each standardized feature vector will contain binary values and have the same dimension. As described herein, the ensemble of the standardized feature vectors for all collected data samples is referred to as a feature map (e.g., the feature map 1320 of FIG. 13). Thus, the feature map is two-dimensional matrix: one dimension of the feature map equals the dimension of the super feature set, and another dimension of the feature map equals the total number of collected data samples.

After constructing the feature map, the machine learning model 1330 can be trained. Specifically, for each data sample, its standardized feature vector can be fed as an input and the corresponding carbon footprint value can be fed as an output of the machine learning model 1330.

### Example 12—Example Method of Estimating Carbon Footprint Using Trained Machine Learning Model

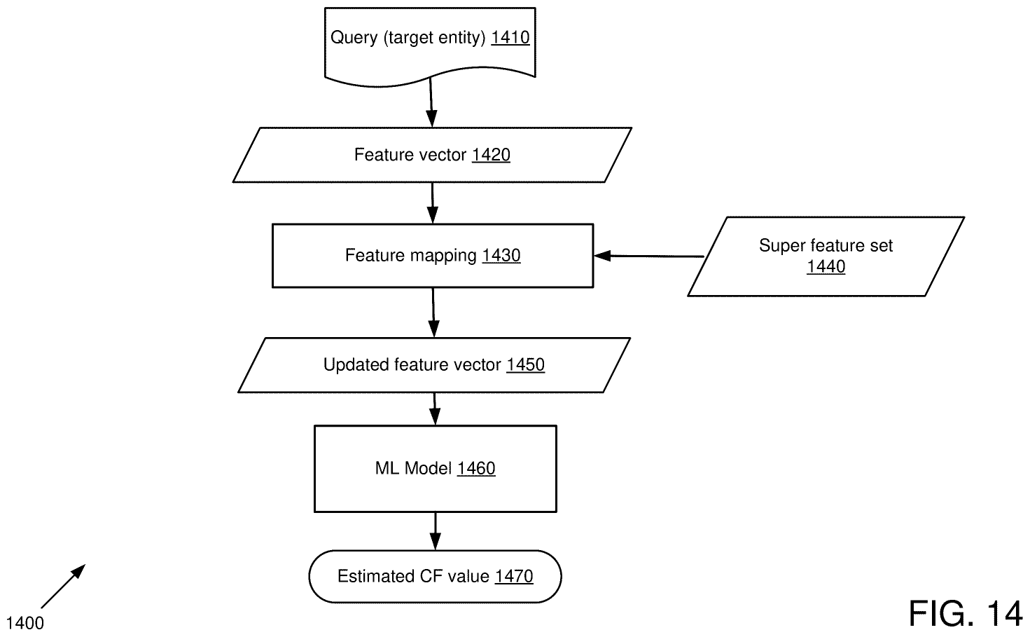

FIG. 14 is a flow diagram illustrating an example method 1400 of estimating carbon footprint of an entity which has no corresponding bill of materials information.

As shown, a query 1410 is received including a target entity (e.g., a new product) which has no corresponding bill of materials.

A feature vector 1420 of the target entity can be extracted. This extracted feature vector 1420 can include a plurality of features (e.g., pairs of feature names and feature values) that characterize properties and/or status of the target entity.

Then, feature mapping 1430 can be performed to map the feature vector 1420 of the target entity to a super feature set 1440. In some examples, the feature mapping 1430 can be performed, e.g., by the feature analyzer 140 of FIG. 1. As described above, the super feature set 1440 can be constructed as a union of all object features collected from a net graph. The result of the feature mapping 1430 is an updated feature vector 1450, which has the same dimension as the super feature set 1440 (i.e., the dimension of the updated feature vector 1450 can be larger than that of the original feature vector 1420 of the target entity).

As described herein, the feature mapping 1430 can map each feature in the feature vector 1420 of the target entity to a corresponding feature in the super feature set 1440. The resulting updated feature vector 1450 is a binary vector similar to the standardized feature vectors described above.

For example, if a feature in the feature vector 1420 is identical to one of the features in the super feature set 1440 (e.g., feature F1 as shown in the above examples), the corresponding element of the updated feature vector 1450 can be set to 1. On the other hand, if a feature in the feature vector 1420 has no identical feature found in the super feature set 1440, then an algorithm (e.g., the k-nearest neighbors search algorithm, or word-embedding algorithms, etc.) can be used to find a correlated feature in the super feature set 1440. Then, the element of the updated feature vector 1450 corresponding to the correlated feature can be set to 1. The remaining elements of the updated feature vector 1450 that are not mapped to any feature in the feature vector 1420 can be set to 0. As described herein, the updated feature vector 1450 can also be referred to as a nearest neighbor of the feature vector 1420.

Finally, the updated feature vector 1450 can be fed to the input of a trained machine learning model 1460 (e.g., the trained machine learning model 1330 of FIG. 13). The output of the machine learning model 1460 is an estimated carbon footprint value 1470 for the target entity, which can be returned in response to the received query 1410.

### Example 13—Example Advantages

A number of advantages can be achieved via the technologies described herein.

When entities (e.g., products, components, raw materials, etc.) have corresponding bills of materials, the technologies described herein can assess the carbon footprint of those entities based on a net graph constructed from those materials. The net graph can be constructed/updated dynamically, e.g., nodes of the net graph can be created on demand, thus avoiding the need of creating and maintaining a complete net graph to represent all possible objects included in the bills of materials, which can be computationally expensive in terms of computing time and memory/storage usage. Additionally, the carbon footprint values of nodes in the net graph can also be determined on demand, thus avoiding the need of pre-calculating the carbon footprint values for all nodes in the net graph, which can be time consuming and may waste computing resources.

When an entity has no corresponding bill of materials, the technologies described herein can still provide an estimate of the entity's carbon footprint using a trained machine learning model, based on a feature vector of the entity. The machine learning model can be trained using object features and carbon footprint values extracted from an existing net graph which has been previously constructed based on one or more available bills of materials.

Thus, the technologies described herein not only can accurately determine a product's carbon footprint when a bill of materials corresponding to the product is available, but also can reasonably estimate the product's carbon footprint even if the product has no corresponding bill of materials, thereby making the task of carbon footprint assessment to be independent of a product's process flow data and/or suppliers of the product's components.

### Example 14—Example Computing Systems

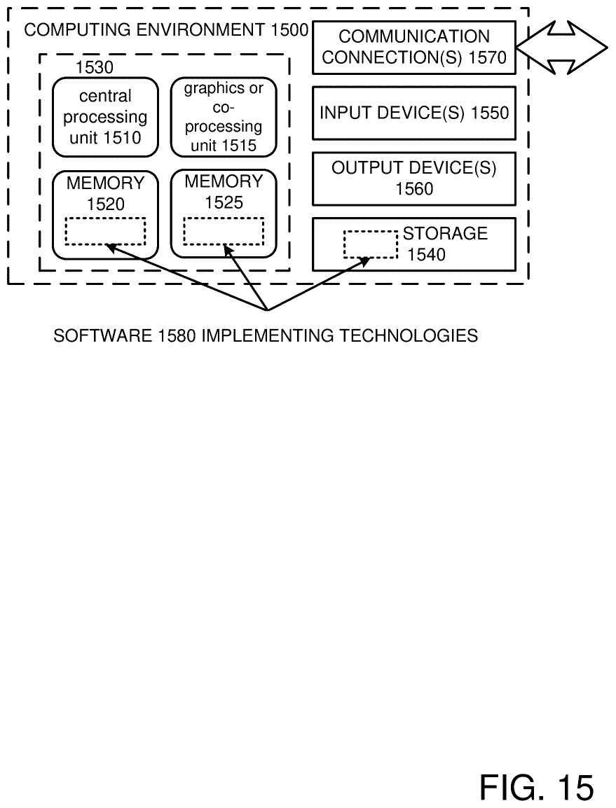

FIG. 15 depicts an example of a suitable computing system 1500 in which the described innovations can be implemented. The computing system 1500 is not intended to suggest any limitation as to scope of use or functionality of the present disclosure, as the innovations can be implemented in diverse computing systems.

With reference to FIG. 15, the computing system 1500 includes one or more processing units 1510, 1515 and memory 1520, 1525. In FIG. 15, this basic configuration 1530 is included within a dashed line. The processing units 1510, 1515 can execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 15 shows a central processing unit 1510 as well as a graphics processing unit or co-processing unit 1515. The tangible memory 1520, 1525 can be volatile memory (e.g., registers, cache, RAM), non-volatile memory (e.g., ROM, EEPROM, flash memory, etc.), or some combination of the two, accessible by the processing unit(s) 1510, 1515. The memory 1520, 1525 can store software 1580 implementing one or more innovations described herein, in the form of computer-executable instructions suitable for execution by the processing unit(s) 1510, 1515.

A computing system 1500 can have additional features. For example, the computing system 1500 can include storage 1540, one or more input devices 1550, one or more output devices 1560, and one or more communication connections 1570, including input devices, output devices, and communication connections for interacting with a user. An interconnection mechanism (not shown) such as a bus, controller, or network can interconnect the components of the computing system 1500. Typically, operating system software (not shown) can provide an operating environment for other software executing in the computing system 1500, and coordinate activities of the components of the computing system 1500.

The tangible storage 1540 can be removable or non-removable, and includes magnetic disks, magnetic tapes or cassettes, CD-ROMs, DVDs, or any other medium which can be used to store information in a non-transitory way and which can be accessed within the computing system 1500. The storage 1540 can store instructions for the software and/or methods implementing one or more innovations described herein.

The input device(s) 1550 can be an input device such as a keyboard, mouse, pen, or trackball, a voice input device, a scanning device, touch device (e.g., touchpad, display, or the like) or another device that provides input to the computing system 1500. The output device(s) 1560 can be a display, printer, speaker, CD-writer, or another device that provides output from the computing system 1500.

The communication connection(s) 1570 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 15—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 16—Example Cloud Computing Environment

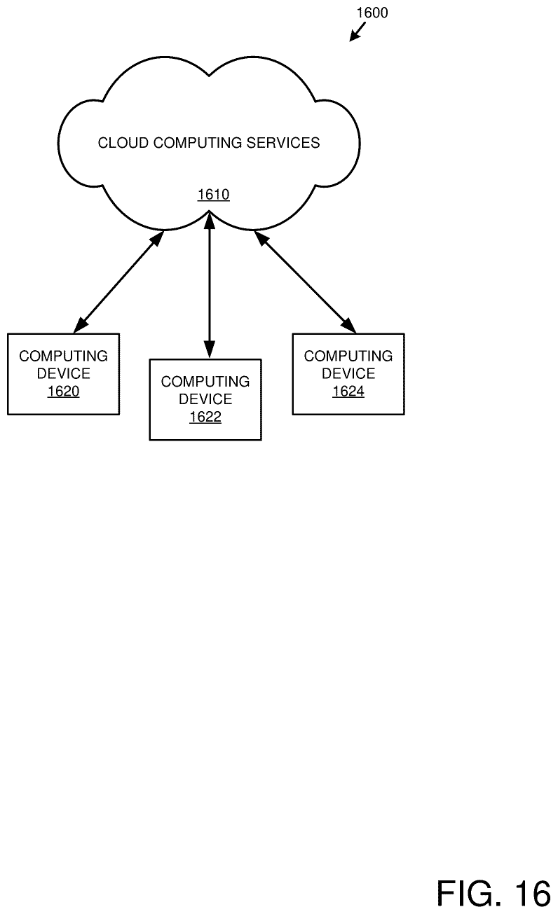

FIG. 16 depicts an example cloud computing environment 1600 in which the described technologies can be implemented, including, e.g., the system disclosed above and other systems herein. The cloud computing environment 1600 can include cloud computing services 1610. The cloud computing services 1610 can comprise various types of cloud computing resources, such as computer servers, data storage repositories, networking resources, etc. The cloud computing services 1610 can be centrally located (e.g., provided by a data center of a business or organization) or distributed (e.g., provided by various computing resources located at different locations, such as different data centers and/or located in different cities or countries).

The cloud computing services 1610 can be utilized by various types of computing devices (e.g., client computing devices), such as computing devices 1620, 1622, and 1623. For example, the computing devices (e.g., 1620, 1622, and 1624) can be computers (e.g., desktop or laptop computers), mobile devices (e.g., tablet computers or smart phones), or other types of computing devices. For example, the computing devices (e.g., 1620, 1622, and 1624) can utilize the cloud computing services 1610 to perform computing operations (e.g., data processing, data storage, and the like).

In practice, cloud-based, on-premises-based, or hybrid scenarios can be supported.

### Example 17—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 18—Example Embodiments

Any of the following examples can be implemented.

Example 1. A computer-implemented method comprising: instantiating a net graph based on one or more existing bills of materials for one or more known entities, wherein the net graph comprises a plurality of interconnected nodes representing different objects included in the one or more known entities, wherein the one or more existing bills of materials define relationship between the objects; determining carbon footprint values of the objects represented by the nodes; collecting vectors of object features and carbon footprint values corresponding to selected nodes in the net graph; training a machine learning model using the collected vectors of object features and the carbon footprint values corresponding to the selected nodes; receiving a request associated with a target entity different from the one or more known entities; and responsive to the request, generating an estimated carbon footprint value for the target entity based on the machine learning model.

Example 2. The method of example 1, wherein generating the estimated carbon footprint value for the target entity comprises: identifying a feature vector for the target entity; and determining a nearest neighbor of the feature vector based on the collected vectors of object features corresponding to the selected nodes.

Example 3. The method of any one of examples 1-2, wherein determining the carbon footprint value for an object represented by a given node comprises: querying a trie data structure to identify a string that matches an identifier of the object, wherein the trie data structure comprises a collection of strings representing identifiers of the objects; and retrieving a reference associated with the identified string from the trie data structure, wherein the reference locates the given node in the net graph.

Example 4. The method of any one of examples 1-3, wherein instantiating the net graph comprises linking the nodes by directional edges, wherein the directional edges represent hierarchical relationship between the objects represented by the nodes based on the one or more existing bills of materials.

Example 5. The method of any one of examples 1-4, wherein determining the carbon footprint value for an object represented by a given node is invoked on demand.

Example 6. The method of any one of examples 1-5, wherein determining the carbon footprint value for an object represented by a given node comprises: recursively finding descendant nodes of the given node; and calculating the carbon footprint value for the object represented by the given node based on the carbon footprint values for the objects represented by the descendant nodes of the given node.

Example 7. The method of any one of examples 1-6, further comprising updating the net graph from an initial version of the net graph to an updated version of the net graph based on a new bill of material for a new entity, wherein the new entity comprises at least one new object that is not represented by the nodes in the initial version of the net graph.

Example 8. The method of example 7, wherein the new entity comprises one or more common objects that are shared by the one or more known entities, wherein the initial version of the net graph and the updated version of the net graph share one or more common nodes representing the one or more common objects, respectively.

Example 9. The method of example 8, wherein updating the net graph comprises:
creating a new node representing the new object; and connecting the new node to at least one of the common nodes based on relationship between the new objects and the one or more common objects defined in the new bill of material.

Example 10. The method of example 9, wherein creating the new node is invoked on identifying the at least one new object.

Example 11. A computing system comprising: memory; one or more hardware processors coupled to the memory; and one or more computer readable storage media storing instructions that, when loaded into the memory, cause the one or more hardware processors to perform operations comprising: instantiating a net graph based on one or more existing bills of materials for one or more known entities, wherein the net graph comprises a plurality of interconnected nodes representing different objects included in the one or more known entities, wherein the one or more existing bills of materials define relationship between the objects; determining carbon footprint values of the objects represented by the nodes; collecting vectors of object features and carbon footprint values corresponding to selected nodes in the net graph; training a machine learning model using the collected vectors of object features and the carbon footprint values corresponding to the selected nodes; receiving a request associated with a target entity different from the one or more known entities; and responsive to the request, generating an estimated carbon footprint value for the target entity based on the machine learning model.

Example 12. The system of example 11, wherein generating the estimated carbon footprint value for the target entity comprises: identifying a feature vector for the target entity; and determining a nearest neighbor of the feature vector based on the collected vectors of object features corresponding to the selected nodes.

Example 13. The system of any one of examples 11-12, wherein determining the carbon footprint value for an object represented by a given node comprises: querying a trie data structure to identify a string that matches an identifier of the object, wherein the trie data structure comprises a collection of strings representing identifiers of the objects; and retrieving a reference associated with the identified string from the trie data structure, wherein the reference locates the given node in the net graph.

Example 14. The system of any one of examples 11-13, wherein instantiating the net graph comprises linking the nodes by directional edges, wherein the directional edges represent hierarchical relationship between the objects represented by the nodes based on the one or more existing bill of materials.

Example 15. The system of any one of examples 11-14, wherein determining the carbon footprint value for an object represented by a given node comprises: recursively finding descendant nodes of the given node; and calculating the carbon footprint value for the object represented by the given node based on the carbon footprint values for the objects represented by the descendant nodes of the given node.

Example 16. The system of any one of examples 11-15, wherein the operations further comprise updating the net graph from an initial version of the net graph to an updated version of the net graph based on a new bill of material for a new entity, wherein the new entity comprises at least one new object that is not represented by the nodes in the initial version of the net graph.

Example 17. The system of example 16, wherein the new entity comprises one or more common objects that are shared by the one or more known entities, wherein the initial version of the net graph and the updated version of the net graph share one or more common nodes representing the one or more common objects, respectively.

Example 18. The system of example 17, wherein updating the net graph comprises: creating a new node representing the new object; and connecting the new node to at least one of the common nodes based on relationship between the new objects and the one or more common objects defined in the new bill of material.

Example 19. The system of example 18, wherein creating the new node is invoked on identifying the at least one new object.

Example 20. One or more non-transitory computer-readable media having encoded thereon computer-executable instructions causing one or more processors to perform a method comprising: instantiating a net graph based on one or more existing bills of materials for one or more known entities, wherein the net graph comprises a plurality of interconnected nodes representing different objects included in the one or more known entities, wherein the one or more existing bill of materials define relationship between the objects; determining carbon footprint values of the objects represented by the nodes; collecting vectors of object features and carbon footprint values corresponding to selected nodes in the net graph; training a machine learning model using the collected vectors of object features and the carbon footprint values corresponding to the selected nodes; receiving a request associated with a target entity different from the one or more known entities; and responsive to the request, generating an estimated carbon footprint value for the target entity based on the machine learning model, wherein generating the estimated carbon footprint value for the target entity comprises identifying a feature vector for the target entity, and determining a nearest neighbor of the feature vector based on the collected vectors of object features corresponding to the selected nodes, wherein determining the carbon footprint value for an object represented by a given node comprises recursively finding descendant nodes of the given node, and calculating the carbon footprint value for the object represented by the given node based on the carbon footprint values for the objects represented by the descendant nodes of the given node.

### Example 19—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
instantiating a net graph based on one or more existing bills of materials for one or more known entities, wherein the net graph comprises a plurality of interconnected nodes representing different objects included in the one or more known entities, wherein the one or more existing bills of materials define relationship between the objects;
determining carbon footprint values of the objects represented by the nodes;
collecting vectors of object features and carbon footprint values corresponding to selected nodes in the net graph;
training a machine learning model using the collected vectors of object features and the carbon footprint values corresponding to the selected nodes;
receiving a request associated with a target entity different from the one or more known entities; and
responsive to the request, generating an estimated carbon footprint value for the target entity based on the machine learning model.

2. The method of claim 1, wherein generating the estimated carbon footprint value for the target entity comprises:
identifying a feature vector for the target entity; and
determining a nearest neighbor of the feature vector based on the collected vectors of object features corresponding to the selected nodes.

3. The method of claim 1, wherein determining the carbon footprint value for an object represented by a given node comprises:
querying a trie data structure to identify a string that matches an identifier of the object, wherein the trie data structure comprises a collection of strings representing identifiers of the objects; and
retrieving a reference associated with the identified string from the trie data structure, wherein the reference locates the given node in the net graph.

4. The method of claim 1, wherein instantiating the net graph comprises linking the nodes by directional edges, wherein the directional edges represent hierarchical relationship between the objects represented by the nodes based on the one or more existing bills of materials.

5. The method of claim 1, wherein determining the carbon footprint value for an object represented by a given node is invoked on demand.

6. The method of claim 1, wherein determining the carbon footprint value for an object represented by a given node comprises:
recursively finding descendant nodes of the given node; and
calculating the carbon footprint value for the object represented by the given node based on the carbon footprint values for the objects represented by the descendant nodes of the given node.

7. The method of claim 1, further comprising updating the net graph from an initial version of the net graph to an updated version of the net graph based on a new bill of material for a new entity, wherein the new entity comprises at least one new object that is not represented by the nodes in the initial version of the net graph.

8. The method of claim 7, wherein the new entity comprises one or more common objects that are shared by the one or more known entities, wherein the initial version of the net graph and the updated version of the net graph share one or more common nodes representing the one or more common objects, respectively.

9. The method of claim 8, wherein updating the net graph comprises:
creating a new node representing the new object; and
connecting the new node to at least one of the common nodes based on relationship between the new objects and the one or more common objects defined in the new bill of material.

10. The method of claim 9, wherein creating the new node is invoked on identifying the at least one new object.

11. A computing system comprising:
memory;
one or more hardware processors coupled to the memory; and
one or more computer readable storage media storing instructions that, when loaded into the memory, cause the one or more hardware processors to perform operations comprising:
instantiating a net graph based on one or more existing bills of materials for one or more known entities, wherein the net graph comprises a plurality of interconnected nodes representing different objects included in the one or more known entities, wherein the one or more existing bills of materials define relationship between the objects;
determining carbon footprint values of the objects represented by the nodes;
collecting vectors of object features and carbon footprint values corresponding to selected nodes in the net graph;
training a machine learning model using the collected vectors of object features and the carbon footprint values corresponding to the selected nodes;
receiving a request associated with a target entity different from the one or more known entities; and
responsive to the request, generating an estimated carbon footprint value for the target entity based on the machine learning model.

12. The system of claim 11, wherein generating the estimated carbon footprint value for the target entity comprises:
identifying a feature vector for the target entity; and
determining a nearest neighbor of the feature vector based on the collected vectors of object features corresponding to the selected nodes.

13. The system of claim 11, wherein determining the carbon footprint value for an object represented by a given node comprises:
querying a trie data structure to identify a string that matches an identifier of the object, wherein the trie data structure comprises a collection of strings representing identifiers of the objects; and
retrieving a reference associated with the identified string from the trie data structure, wherein the reference locates the given node in the net graph.

14. The system of claim 11, wherein instantiating the net graph comprises linking the nodes by directional edges, wherein the directional edges represent hierarchical relationship between the objects represented by the nodes based on the one or more existing bill of materials.

15. The system of claim 11, wherein determining the carbon footprint value for an object represented by a given node comprises:
recursively finding descendant nodes of the given node; and
calculating the carbon footprint value for the object represented by the given node based on the carbon footprint values for the objects represented by the descendant nodes of the given node.

16. The system of claim 11, wherein the operations further comprise updating the net graph from an initial version of the net graph to an updated version of the net graph based on a new bill of material for a new entity, wherein the new entity comprises at least one new object that is not represented by the nodes in the initial version of the net graph.

17. The system of claim 16, wherein the new entity comprises one or more common objects that are shared by the one or more known entities, wherein the initial version of the net graph and the updated version of the net graph share one or more common nodes representing the one or more common objects, respectively.

18. The system of claim 17, wherein updating the net graph comprises:
creating a new node representing the new object; and
connecting the new node to at least one of the common nodes based on relationship between the new objects and the one or more common objects defined in the new bill of material.

19. The system of claim 18, wherein creating the new node is invoked on identifying the at least one new object.

20. One or more non-transitory computer-readable media having encoded thereon computer-executable instructions causing one or more processors to perform a method comprising:
instantiating a net graph based on one or more existing bills of materials for one or more known entities, wherein the net graph comprises a plurality of interconnected nodes representing different objects included in the one or more known entities, wherein the one or more existing bill of materials define relationship between the objects;
determining carbon footprint values of the objects represented by the nodes;
collecting vectors of object features and carbon footprint values corresponding to selected nodes in the net graph;
training a machine learning model using the collected vectors of object features and the carbon footprint values corresponding to the selected nodes;
receiving a request associated with a target entity different from the one or more known entities; and
responsive to the request, generating an estimated carbon footprint value for the target entity based on the machine learning model,
wherein generating the estimated carbon footprint value for the target entity comprises identifying a feature vector for the target entity, and determining a nearest neighbor of the feature vector based on the collected vectors of object features corresponding to the selected nodes,
wherein determining the carbon footprint value for an object represented by a given node comprises recursively finding descendant nodes of the given node, and calculating the carbon footprint value for the object represented by the given node based on the carbon footprint values for the objects represented by the descendant nodes of the given node.
